(19) United States
(12) Patent Application Publication
(10) Pub. No.: US 2004/0075193 A1
(43) Pub. Date: Apr. 22, 2004

(54) Process for the use of polymeric materials to produce molded products

(75) Inventor: Dennis M. Danzik, Scottsdale, AZ (US)

Correspondence Address: THORPE NORTH & WESTERN, LLP., 8180 SOUTH 700 EAST, SUITE 200, P.O. BOX 1219, SANDY, UT, 84070, US

(73) Assignee: Applied Polymer Sciences LLC.

(21) Appl. No.: 10/455,260

(22) Filed: Jun. 4, 2003

Related U.S. Application Data
(60) Provisional application No. 60/419,410, filed on Oct. 18, 2002.
(60) Provisional application No. 60/419,411, filed on Oct. 18, 2002.
(60) Provisional application No. 60/419,412, filed on Oct. 18, 2002.
(60) Provisional application No. 60/419,565, filed on Oct. 18, 2002.
(60) Provisional application No. 60/419,730, filed on Oct. 18, 2002.

(51) Int. Cl. B29C 41/04

(52) U.S. Cl. 264/310; 264/349; 264/523; 264/328.18

(57) ABSTRACT

A particulate polymeric blend for use in the formation of molded products formed in the absence of a compounding and/or extruding step prior to molding. A quantity of reactor flake is blended with at least one additive at a temperature below the melting temperature of the reactor flake to form a particulate polymeric blend. A wide variety of polymeric reactor flake can be used to produce molded products. Molded products produced using these particulate polymeric blends exhibit superior physical properties. Molding processes utilizing such particulate polymeric blends can avoid the use of expensive compounding and pelletizing steps which degrade the quality of the molded polymer.

### PRIORITY CLAIM

This application claims priority to U.S. Provisional Patent Application Nos. 60/419,410; 60/419,411; 60/419,412; 60/419,565; and 60/419,730 each filed Oct. 18, 2002, and are each hereby incorporated by reference in their respective entireties.

### BACKGROUND OF THE INVENTION

1. Field of the Invention

The present invention relates generally to polymeric molding processes. As such the invention related generally to the fields of chemistry and material processing.

2. Related Art

The past several decades has seen a dramatic increase in the use of polymeric molded articles. For example, growth rates of rotational molding processes have reached up to about 30% per year historically. Rotational molding processes account for a small percentage of the entire plastics molding industry; however the absolute quantities involved are nevertheless substantial, amounting to over 800 million pounds annually. Currently, polyethylene represents about 85% to 95% of all polymers that are rotationally molded. PVC plastisols are widely used while polycarbonates, polyamides, polypropylenes, unsaturated polyesters, ABS, acrylics, cellulosics, epoxies, fluorocarbons, phenolics, polybutylenes, polystyrenes, polyurethanes and silicones constitute the remaining commonly used polymers. A wide variety of rotational molding processes are known for achieving various product designs. Rotationally molded products can be hollow, double walled, single wall foamed, double wall foamed, and a considerable number of other shaped products. Rotational molding processes can incorporate molded parts which include solid inserts, structural members, and the like. Modern Plastics Encyclopedia, pp D-179-180 describes some machinery and materials which can be used in rotational molding and is incorporated herein by reference.

Raw materials available for use in molding has increased dramatically in recent years and includes polymers such as polyethylenes, polypropylenes, polyamides, polyvinyl chlorides, thermosets such as polyesters, and numerous other materials. Commercial options for color selection, multicolor, and foaming processes for polyethylene and polypropylene in particular have improved in recent years. Typical molding processes involve processing of raw polymer from the reactor through an extruder to form pellets. During this extrusion process the polymer is heated while certain additives such as antioxidants and UV absorbers are added. This formed pellet is then further processed using dry blending and/or compounding steps to introduce colorants, blowing agents, and/or further additives. During the compounding process the pellets are again subjected to heat and pressure and then ground to the appropriate mesh size for molding.

### SUMMARY OF THE INVENTION

It has been recognized that it would be advantageous to develop an improved process for preparing and producing materials suitable for use in various molding processes which avoid expensive and time consuming compounding and extrusion processes.

The invention provides a method of producing a particulate polymeric blend for use in the formation of rotationally molded products including the steps consisting essentially of providing polymeric reactor flakes and blending into the reactor flakes at least one additive to form a particulate polymeric blend. The blending process is maintained at temperatures below the melting temperature of the reactor flake.

The polymeric reactor flake can be a wide variety of polymeric materials such as polyethylenes, polypropylenes, polyurethanes, polyvinyl chlorides, polyamides, polyesters, styrenes, ethylvinyl acetates, acrylonitrile-butadiene-styrenes, polycarbonates, acrylonitrilestyrene-acrylates, polyphenylene ethers, fluorocarbons, and mixtures and copolymers thereof.

In one detailed aspect of the present invention, the polymeric reactor flake is polyethylene.

In yet another more detailed aspect of the present invention, additives can be blended with the reactor flakes such as dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

In another aspect of the present invention, the polymeric reactor flake can have almost any mesh size and in one aspect has an average mesh size of from about 10 mesh to about 100 mesh.

In still another detailed aspect of the present invention, a filler can be added to the particulate blend such as fiberglass, wood, wood flour, cellulose, waste paper, waste pulp, glass, glass beads, recycled plastics, carbon black, titanium dioxide, and mixtures thereof.

In another aspect of the present invention, the particulate polymeric blend can be molded under pressure and/or heat to form a polymeric product. Molding can be performed by a molding process such as rotational molding, blow molding, injection molding, sheet molding, static molding, and combinations thereof.

Additional features and advantages of the invention will be apparent from the detailed description which follows, taken in conjunction with the accompanying drawings, which together illustrate, by way of example, features of the invention.

### BRIEF DESCRIPTION OF THE DRAWING

FIG. 1 is a flow diagram of one embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It should be noted that, as used in this specification and the appended claims, the singular forms “a,” “an,” and, “the” include plural referents unless the context clearly dictates otherwise. Thus, for example, reference to “an additive” includes one or more of such additives and reference to “a mixer” includes reference to one or more of such mixers.

In describing and claiming the present invention, the following terminology will be used in accordance with the definitions set forth below.

As used herein, “reactor flake” refers to polymeric reactor product which is unprocessed following the polymerization process. In context of the present invention, reactor flake is essentially free of subsequent compounding, extruding, or any other process which involves substantial heat and/or pressure sufficient to cause melting or a material change to the reactor flake as originally produced. Thus, as used herein, a reactor flake which is pelletized is no longer a reactor flake.

As used herein, “low heat” refers to heat which is insufficient to cause melting of the reactor flake or degradation or change in the chemical and/or physical properties of the reactor flake. In some embodiments, low heat can be used to melt various additives without melting the reactor flake. Thus, low heat includes temperatures from below ambient up to, and not including, the melting temperature of the reactor flake.

As used herein, “melt index” refers to the standardized ASTM measurement of the grams of polymer which can be forced through a die of a specified size at a given temperature and pressure over a 10 minute period. For example, the melt index of polyethylene is measured at 190° C. and application of a 298 kPa force through a 2.1 mm diameter and 8.0 mm length die (polypropylene is measured at 230° C. and the same conditions). The melt indexes and associated measurement conditions of other polymers is well known to those skilled in the art and can be determined by reference to standard technical literature.

As used herein, “complete cooling” refers to the point at which the previously molten polymeric material no longer flows under the molding conditions applied to the material.

As used herein, “substantial” when used in reference to a quantity or amount of a material, or a specific characteristic thereof, refers to an amount that is sufficient to provide an effect that the material or characteristic was intended to provide. Further, “substantially free” when used in reference to a quantity or amount of a material, or a specific characteristic thereof, refers to the absence of the material or characteristic, or to the presence of the material or characteristic in an amount that is insufficient to impart a measurable effect, normally imparted by such material or characteristic.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 mesh to about 100 mesh” should be interpreted to include not only the explicitly recited values of about 10 mesh to about 100 mesh, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

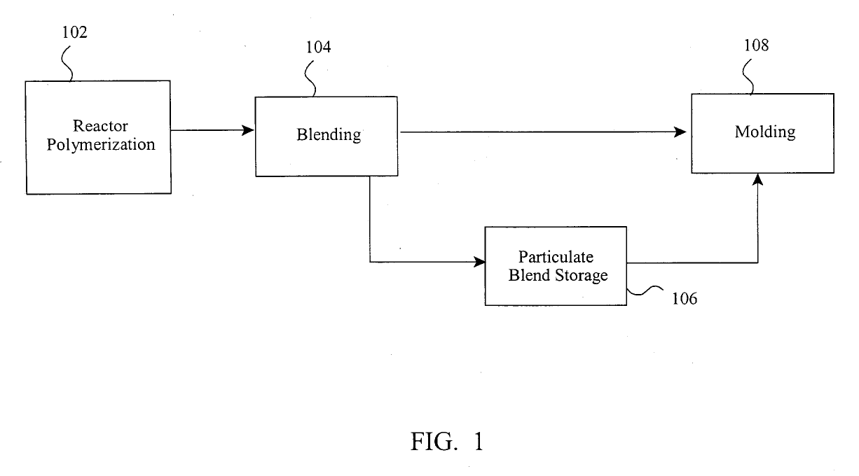

Referring now to FIG. 1, a brief overview of the method of the present invention is provided. A polymeric reactor flake is selected based on the desired properties of a final molded product. The reactor flake is typically a powdered product of a polymerization reaction and a variety of known polymerization processes are known to those skilled in the art. In accordance with the present invention, a quantity of reactor flake is provided at step 102. The reactor flake can then be blended under low heat conditions with an optional additive in step 104 to form a particulate polymeric blend. The particulate polymeric blend can be stored in appropriate means 106 or immediately used in molding step 108. Further additives can be added to the blend during step 104 or at a later step. Following the blending step 104, the particulate blend is suitable for direct use in various molding processes such as rotational molding. In step 108 the particulate blend is molded into a final product.

In one aspect of the present invention, a particulate polymeric blend for use in forming rotationally molded products utilizes reactor flake which has not been subjected to heat treatments above the melting temperature of the reactor flake prior to molding a final product. Polymeric reactor flakes suitable for use in the present invention can exhibit a variety of properties depending on the reactor conditions. The polymeric reactor flakes can include polymers such as, but not limited to, polyethylenes (including LLDPE, LDPE, HDPE, PET, etc.), polypropylenes, polyurethanes, polyvinyl chlorides (PVC), polyamides, polyesters, styrenes, ethylvinyl acetates, acrylonitrile-butadiene-styrenes (ABS), polycarbonates, acrylonitrile-styrene-acrylates, polyphenylene ethers, fluorocarbons, other elastomeric olefins, butane and hexene based copolymer resins, and mixtures and copolymers thereof. In one specific embodiment of the present invention, the polymeric reactor flake is a polyethylene. In another embodiment, the polymeric reactor flake is HDPE. Polymeric reactor flake of the present invention exhibits high flowability. The lack of a pelletizing and/or grinding step leaves the reactor flake in relatively homogeneous crystalline shapes. Grinding processes leave sharp edges and “tails” which partially interlock among the particles thus decreasing the flowability of the particulate product. The reactor flake and blends resulting therefrom are capable of filling intricate molds. Additionally, the reactor flake of the present invention is not subjected to processing steps prior to molding which involve heating above the melting temperature of the reactor flake. Thus, in one aspect of the present invention temperatures can be maintained below about 90° C. or about 85° C. during the blending process and up to the step of molding. Temperatures above this range can be used depending on the specific polymer reactor flake chosen, so long as the reactor flake is not melted or otherwise permanently changed in mechanical or chemical properties.

In another aspect of the present invention, the polymeric reactor flake has an average particle size of from about 10 mesh to about 100 mesh, such as about 35 mesh and can also be less than about 35 mesh. These mesh size ranges are provided merely as illustrative, as mesh sizes outside this range could also be used effectively in the present invention and appropriate adjustments to molding times and processing can be made by those skilled in the art. Additionally, the methods and processes of the present invention can successfully utilize a wide variety of polymer reactor flake having almost any melt index. In one aspect of the present invention the melt index of the reactor flake is from about 0.1 to about 50, and can be from about 4 to about 10 although reactor flake having melt indexes outside this range can also be used. The only limitation as to size and melt index is that of functionality. Current technologies produce reactor flake using slurry or gas phase processes, however any reactor flake product having suitable melt properties can be used in the present invention. Optimal sizes and/or melt indices can be readily determined by one skilled in the art by routine experimentation and may vary depending upon the particular reactor flake being utilized.

The reactor flake can be blended with optional additives to form a particulate polymeric blend. In one aspect of the present invention, the reactor flakes are blended using a standard mixer such as a ribbon mixer, blade mixer, wisk-type mixers, rotary drum mixers, other low or high speed blenders, or similar mixers which do not substantially heat the particulates. Typically, the mixer is also operated at ambient pressures for less than about 30 minutes and more typically from 1 to about 20 minutes. During this blending step a variety of optional additives can be added such as, but not limited to, dispersion agents, enhancers, stabilizers, colorants, fillers, crosslinking agents, plasticizers, static inhibitors, pentaerythritol monooleate, glycerol monostearate, mineral oil, lubricants, flame retardants, binders such as bentonite clay, waxes, and other adhesives, and mixtures thereof. In addition, various additives can be added at a later time just prior to or during the molding process and such addition is considered within the scope of the present invention as not substantially affecting the basic inventive process. Additives can be blended into the reactor flake to achieve a wide range of effects on physical and/or chemical properties such as densities, aesthetic variables, tensile strength, softness, ductility, impact resistance, final surface finish, light stability, and a host of other properties. For example, elastomers and/or plasticizers can be added to increase softness of a polymeric skin product. Additionally, the particulate blend of the present invention allows for uniform distribution of colorants, crosslinking agents such as organic peroxides, and other similar additives which improves the quality and appearance of the final molded product. The inclusion of additives to the particulate polymeric blends of the present invention is highly adjustable to conform to the product specifications of individual products in either large or small batches. Alternatively, in some embodiments the reactor flake can be substantially free of additives and used directly in a molding process. In some cases, such as with additive colorants, low heat can be added in order to melt and evenly disperse the additive in the blend without melting the reactor flake.

In one embodiment of the present invention, a mixer is used in the absence of other extruders, grinders, and/or pulverizers. In this embodiment, the process of the present invention can be readily transported to a desired location and then removed with minimal effort. Further, the blending steps of the present invention do not require careful climate control of humidity and temperature.

The blending process can be performed using solely dry materials or may include liquid carriers such as oils, water, waxes, paraffins, and blends or mixtures thereof. Suitable carriers can be essentially inert or may impart desirable properties to the particulate polymeric blend such as to increase coating or for processing reasons. However, such carriers preferably do not change the basic physical or chemical properties of the reactor flake. In one aspect of the present invention, the reactor flake can be dried either prior to or after the step of blending using a desiccant, low heat, or other known drying processes. The drying process can improve molding quality and reduce waste and scrap materials.

Due to the absence of compounding or other heat treatments, molded products using the method of the present invention do not require antioxidants or light stabilizing components such as UV stabilizers, although such can still be used. Additionally, the particulate polymeric blends of the present invention are not processed in a compounding step and do not include associated additives used in such processes such as anti-foaming agents, dispersion agents (e.g. zinc stearate), and other catalyst scavengers (e.g. zinc, calcium stearate, and the like) which often reduce the effectiveness of colorants and other additives. Further, the addition of known additives either before or after blending is not considered to materially affect the advantages gained by eliminating steps which involve heating prior to the step of molding. Thus, the process of the present invention can include or omit such additives depending on the desired characteristics in the final molded product.

The particulate polymeric blends of the present invention can be molded under elevated temperature (thermoformed or thermoset) or elevated pressure (pressure-formed), although elevated temperatures are currently preferred. The particulate polymeric blend of the present invention can be formed using a wide variety of polymeric reactor flake. The operating temperatures of the present invention are similar to conventional molding processes and are typically from about 275° F. (135° C.) to about 600° F. (315° C.). Pelletized and ground polymeric material typically melts at a higher temperature than the particulate blend of the present invention and results in additional heat requirements and potential degradation of the polymer properties. In addition, additives such as pentaerythritol monooleate and glycerols can lower the processing temperature thus improving the formation of uniformly skin products.

Many commercially molded products utilize various fillers to both decrease costs and/or improve the mechanical properties of the final molded product. In conjunction with the present invention, fillers are an optional component. A wide variety of fillers can be optionally blended into the particulate polymeric blend of the present invention. Such filler materials can be added either before or after blending the optional additives therein. Fillers suitable for use in the present invention include, but are not limited to, fiberglass, wood, wood flour, cellulose, waste paper, waste pulp, glass, glass beads, recycled plastics, carbon black, titanium dioxide, and mixtures thereof. Fillers can be present in the particulate polymeric blend in up to about 70% by weight. The fillers can be almost any size or length and are chosen based on the final molded product specifications. Fillers having a large particle size can be successfully used in the present invention which does not involve a compounding or pelletizing step. Thus, large filler particles sizes and/or fiber lengths can be incorporated into a final molded product. For example, fiberglass having an average length of up to one inch to about four inches can be blended into the particulate reactor flake of the present invention and molded as desired.

In accordance with the present invention, the particulate polymeric blend can be molded into a final product under heated conditions using any number of molding processes. Suitable molding processes include rotational molding, blow molding, injection molding, sheet molding, static molding, and combinations thereof. The particulate polymeric blends of the present invention are particularly suited to use in rotational molding. Rotational molding generally involves rotating a heated mold on at least two axes over a period of time. Specifically, a mold having a desired shape corresponding to a specific product is charged with the particulate polymeric blend of the present invention. The amount of particulate blend is calculated to provide the desired thickness and density based on the available volume within the mold. The high flowability of the particulate blend allows for uniform distribution of polymer throughout the mold, including molds having relatively intricate shapes. Once the mold is charged with the particulate blend the mold is rotated about at least two axes and heated. The heat can be applied by an oven, a steam jacket, electrical heating elements, or any other heating method. As the mold increases in temperature, the particulate blend melts to partially fill the mold. Any excess vapor can be released via a pressure release valve. Care should be taken as the heating rate and amount of various additives will distinctly affect the quality of the final product. Typical operating temperatures are from about 275° F. to about 600° F. Particulate blends of the present invention can be heated from about 4 minutes to about an hour depending on the specific polymeric reactor flake used. Following heating for a given period of time, the heat is removed and the mold is allowed to cool. During at least a substantial portion of the cooling cycle the mold continues to rotate to prevent molten polymer from flowing to create uneven distribution of polymer within the mold. Cooling times can vary but are typically less than about 20 minutes. These variables will vary somewhat depending on the specific polymer and any additives included in the polymeric blend. For example, a polyethylene reactor flake of about 35 mesh having about 5 wt % pentaerythritol monooleate can be heated to about 400° F. within about 10 minutes and then held for about 10 minutes and then cooled.

Upon completion of the cooling cycle the molded product can be removed from the mold. The molded product can then be finished, if needed, to remove undesirable polymer remnants or otherwise shaped for incorporation into a final product. It should be noted that a variety of inserts can also be incorporated into the molded product such as, but not limited to, metal supports, I-beams, gusset plates, and the like. For example, metal reinforcements or metal parts can be placed in appropriate positions within the mold prior to charging the mold with the particulate polymeric blend of the present invention in accordance with known molding techniques. Upon completion of the molding process the inserts are integrally incorporated into the molded plastic.

Commercial molded products frequently include a thin polymeric outer shell or skin surrounding an open void. This skin layer can include multiple layers, inserts, or other features. In accordance with one aspect of the present invention, the skin layer is formed on the interior surface of a rotational mold using a first particulate polymeric blend. In one embodiment, a second particulate polymeric blend is then injected into the mold allowing formation of a secondary layer within the skin layer over at least portions of the mold. Specifically, a portion of polymeric reactor flake can be blended under low heat conditions with optional additives to form a first particulate polymeric blend. A second portion of reactor flakes can be blended under low heat conditions with an effective amount of optional additives to form a second particulate polymeric blend for use as a secondary skin layer. Additional portions of reactor flake can also be blended to achieve multiple layer molded products. Because of the ease with which particulate blends of the present invention can be blended it is sometimes advantageous to prepare various blends from reactor flake just prior to the molding process.

In one detailed aspect of the present invention, the first and second portions of reactor flakes are substantially the same material, i.e. within about 5 melt index units. For example, a quantity of reactor flake can be blended with desired, optional additives, such as those mentioned above. Then a portion of the blended reactor flake can be further blended with or without additives which may differ from the first particulate blend. Thus, the same basic starting material can be used to form each layer or portion of the product. In another detailed aspect of the present invention, the first and second portions of reactor flake are not substantially the same material. The difference between the first and second portion of reactor flake can be average mesh size, melt index, polymeric material, and any combination thereof. For example, the outer skin layer can be polyethylene while an inner layer can be an ABS polymer. In an additional aspect of the present invention, more than two portions of reactor flake can be used to form a multiple layer molded product. Each portion can be of substantially similar or different polymeric materials.

In an alternative embodiment, a portion of the molded product can be formed using standard pelletized polymer and remaining portions can be formed using the blended reactor flake of the present invention. In this way, the cost of producing certain products can be reduced by forming portions of the product using the polymeric blends of the present invention which do not include traditional additives. A wide variety of polymer combinations can be used in the present invention and can be chosen by those skilled in the art based on any particular design criteria.

The particulate polymeric blend for forming the skin can be charged into the mold and then heated as described above. Additionally, prior to complete cooling of the outer skin material additional particulate blends can be introduced into the mold to produce multilayered products. The additional particulate polymeric blend can be introduced prior to removing the heat source, during initial cooling, during later cooling stages, or combinations thereof depending on the melting temperature of the reactor flake. Thus, in some embodiments a reactor flake having a relatively high melting point can be used in the outer layer. The mold can then be cooled to allow the outer skin layer to at least partially solidify. At the lower temperature, a second particulate blend can then be introduced having a melting temperature which is below that of the outer skin. Thus, by choosing reactor flake having various melting temperatures and controlling the sequence of introduction into the mold the layers can be designed to improve lamination between layers or in some cases to decrease lamination of the layers. Thus, the entire charge of particulate blend or blends need not be introduced into the mold at the same time. Although, rotational molding is the currently preferred molding process other molding processes can also be used in connection with the method of the present invention such as blow molding, injection molding, sheet molding, static molding, and combinations thereof. Static molding involves charging a mold with-the particulate polymeric blend and then heating without rotation.

Final molded products of the present invention which use a first and a second portion of reactor flake which are substantially similar have an improved boundary layer. Specifically, as the second particulate polymeric blend is added the similarity of materials allows for an increase in the mixing of materials at the interface between the skin layers materials. As a result, there is generally no distinguishable boundary between the two layers in the final product. This results in improved strength in the final molded product. Further, molded products produced in accordance with the present invention exhibit increased grain size and decreased crystallinity over typical molding processes which involve pelletizing or other heat treatments of the polymer prior to molding. Additionally, the particulate polymeric blends of the present invention can be stored for extended periods of time of up to a year without appreciable polymer degradation. The molded products of the present invention thus exhibit greater light stability, improved toughness, and strength. In some embodiments, the increased toughness can be moderated by adding various plasticizers or other additives which prevent or reduce fracture under applied force.

### EXAMPLE

The following example illustrates an embodiment of the invention. However, it is to be understood that the following is only exemplary or illustrative of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Example provides further detail in connection with what is presently deemed to be a practical embodiment of the invention.

A rotational mold measuring 30 cm long by 15 cm wide by 4 cm thick was used to form various colored rotationally molded skins for laboratory testing. About 400 grams of a polypropylene reactor flake (British Petroleum 9600) was measured and placed in a food processor type mixer. Four grams of a liquid Ergonox 10 antioxidant (available from Ciba-Geigy Corporation) was added to the reactor flake, along with three grams of an ultraviolet hindered amine inhibitor to produce a particulate polymeric blend. The particulate polymeric blend was mixed for about ten minutes. During blending, the temperature of the particulate blend was maintained below about 80° C. The blending process evenly dispersed the additives. The combination of liquids used provided for good dispersion of all additives, and allowed even coating of the reactor flake. The particulate polymeric blend was then placed in the mold. The reactor flake had an average mesh size of 5 to 60 mesh and a melt index of about 3. The mold was then rotated at about 6 rpm and heated to about 200° C. over a time period of about 15 minutes to ensure complete melting of the blend. The heat source was then turned off and the mold containing a molten mixture was then allowed to cool. After the mold reached below about 60° C. the rotational motion was halted and the mold removed to expose the molded skin product.

The molded product exhibited good impact characteristics and was smooth, with a slightly off-white color. There was no visible porosity in the skin. The molded part showed a consistently uniform wall thickness. There was little or no static electricity present upon opening the mold, due to the fact that the liquid additive effectively eliminated static electricity, usually generated in rotational molding.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method of producing a particulate polymeric blend for use in the formation of rotationally molded products comprising the steps consisting essentially of:
a) providing polymeric reactor flakes having a melting temperature; and
b) blending into the reactor flakes an optional additive to form a particulate polymeric blend wherein the blend is maintained at a temperature below the melting temperature of the reactor flakes.

2. The method of claim 1, wherein the polymeric reactor flakes comprise a member selected from the group consisting of polyethylenes, polypropylenes, polyurethanes, polyvinyl chlorides, polyamides, polyesters, styrenes, ethylvinyl acetates, acrylonitrile-butadiene-styrenes, polycarbonates, acrylonitrile-styrene-acrylates, polyphenylene ethers, fluorocarbons, and mixtures and copolymers thereof.

3. The method of claim 2, wherein the polymeric reactor flake is polyethylene.

4. The method of claim 1, wherein an additive is blended into the reactor flake, said additive comprising a member selected from the group consisting of dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

5. The method of claim 4, wherein the additive is a member selected from the group consisting of pentaerythritol monooleate, glycerol monostearate, mineral oil, and mixtures thereof.

6. The method of claim 1, wherein the polymeric reactor flake has an average particle size of from about 10 mesh to about 100 mesh.

7. The method of claim 6, wherein the polymeric reactor flake has an average particles size of about 35 mesh.

8. The method of claim 1, wherein the at least on additive includes a filler, said filler being a member selected from the group consisting of fiberglass, wood, wood flour, cellulose, waste paper, waste pulp, glass, glass beads, recycled plastics, carbon black, titanium dioxide, and mixtures thereof.

9. The method of claim 8, wherein the filler is fiberglass having a fiber length of up to about 3 inches.

10. A method of producing a polymeric product consisting essentially of the steps of:
a) providing polymeric reactor flakes having a melting temperature;
b) blending into the reactor flakes an optional additive to form a particulate polymeric blend such that the blend is maintained at a temperature below the melting temperature of the reactor flakes; and
c) molding the particulate polymeric blend under pressure and/or heat to form a polymeric product.

11. The method of claim 10, wherein the step of molding is performed by a process selected from the group consisting of rotational molding, blow molding, injection molding, sheet molding, static molding, and combinations thereof.

12. The method of claim 11, wherein the step of molding is performed by rotational molding.

13. The method of claim 10, wherein the polymeric reactor flakes comprise a member selected from the group consisting of polyethylenes, polypropylenes, polyurethanes, polyvinyl chlorides, polyamides, polyesters, styrenes, ethylvinyl acetates, acrylonitrile-butadiene-styrenes, acrylonitrile-styrene-acrylates, polycarbonates, polyphenylene ethers, fluorocarbons, and mixtures and copolymers thereof.

14. The method of claim 10, wherein an additive is blended into the reactor flake, said additive comprising a member selected from the group consisting of dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

15. The method of claim 14, wherein the additive is pentaerythritol monooleate.

16. A molded product produced by the method of claim 10.

17. A method of producing a molded polymeric product consisting essentially of blending into a first portion of reactor flakes under low heat conditions an optional additive to form a particulate polymeric blend and introducing the particulate polymeric blend into a mold and molding under pressure and/or heat to form a skin polymeric product, wherein the molding is performed by a process selected from the group consisting of rotational molding, blow molding, injection molding, sheet molding, static molding, and combinations thereof.

18. The method of claim 17, further comprising blending a second portion of reactor flakes under low heat conditions with an optional additive to form a second particulate polymeric blend and introducing the second particulate polymeric blend into a mold after introducing the particulate polymeric blend into the mold.

19. The method of claim 18, wherein the first portion and second portion of reactor flakes are not substantially the same material.

20. The method of claim 19, wherein the first portion and second portion of reactor flakes have differing melt indexes.

21. A molded product produced by the method of claim 17.

22. A method of producing a particulate polymeric blend for use in the formation of rotationally molded products comprising:
a) providing polymeric reactor flakes having a melting temperature; and
b) blending into the reactor flakes an optional additive to form a particulate polymeric blend,
such that the particulate polymeric blend is not exposed to temperatures above the melting temperature of the reactor flake prior to molding.

23. The method of claim 22, wherein the reactor flake is not exposed to temperatures above about 90° C. prior to molding.

24. The method of claim 22, wherein the polymeric reactor flakes comprise a member selected from the group consisting of polyethylenes, polypropylenes, polyurethanes, polyvinyl chlorides, polyamides, polyesters, styrenes, ethylvinyl acetates, acrylonitrile-butadiene-styrenes, acrylonitrile-styrene-acrylates, polycarbonates, polyphenylene ethers, fluorocarbons, and mixtures and copolymers thereof.

25. The method of claim 22, wherein the polymeric reactor flakes comprise polyethylene.

26. The method of claim 22, wherein an additive is blended into the reactor flake, said additive comprising a member selected from the group consisting of dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.
